(19) United States
(12) Patent Application Publication
(10) Pub. No.: US 2024/0162464 A1
(43) Pub. Date: May 16, 2024

(54) STANDALONE HYDROGEN FUEL CELLS THAT PROVIDE A VARIABLE AMOUNT OF ELECTRICITY DEPENDING UPON ELECTRICAL DEMAND

(71) Applicants: Gurjeet Gulati, New City, NY (US); Barry Hartsfield, Beverly Hills, CA (US)

(72) Inventors: Gurjeet Gulati, New City, NY (US); Barry Hartsfield, Beverly Hills, CA (US)

(21) Appl. No.: 18/509,164

(22) Filed: Nov. 14, 2023

Related U.S. Application Data
(63) Continuation-in-part of application No. 18/508,065, filed on Nov. 13, 2023.
(60) Provisional application No. 63/383,657, filed on Nov. 14, 2022.
(60) Provisional application No. 63/383,425, filed on Nov. 11, 2022.

(51) Int. Cl. H01M 8/0656; H01M 8/04082; H01M 8/04276; H01M 8/04746; H01M 8/04858

(52) U.S. Cl. CPC H01M 8/0656; H01M 8/04216; H01M 8/04276; H01M 8/04753; H01M 8/04776; H01M 8/04932

(57) ABSTRACT

The present invention is a system and method for providing a variable amount of electrical power according to varying electrical demands, wherein a fuel cell system varies the amount of hydrogen gas that is generated in order to vary the amount of electricity that is generated, the system modifying the size and surface area of aluminum particles that are inserted into the reaction vessel, the system using a pressure control system to regulate the pressure of hydrogen gas within the reaction vessel, the system regulating the transfer rate of hydrogen, and the system regulating the volume of hydrogen gas that is transferred to a hydrogen conversion system to thereby vary the amount of electricity that is generated by the fuel cell system.

### BACKGROUND

### Field of the Invention

This invention relates generally to power systems that enable wireless charging of electric vehicles. More specifically, the road segments provide wireless charging may be far from connections to an electric grid, and therefore require an alternate means of power. The powered road segments obtain electricity from standalone hydrogen fuel cells.

### Description of Related Art

Alternative fuel vehicles are becoming ubiquitous on roadways, but efforts to fuel them are difficult. Electric and hybrid vehicles that include gas engines and electric motors are also gaining popularity. However, charging these vehicles remains difficult as the infrastructure to provide electrical charging stations is slow to be built.

One possible solution to the problem of charging electrically powered vehicles is the installation of roads or road segments that are disposed adjacent to the regular roadway. These charging roads would include technology that enables wireless charging of a vehicle battery while the vehicle is still traveling. The prior art shows many examples of electrically powered roads that include inductive charging systems.

Inductive charging systems have been developed in which no cord is needed between a charging system and the electric vehicle. Instead, wireless charging systems may be embedded in or just under the surface of the road, thereby enabling a vehicle traveling on the road to be charged while it is stopped or traveling on the roadway. However, providing electrical power to the charging road segments is taught in the prior art as requiring direct access to an electrical power grid.

It is useful to look at one particular example of a prior art roadway in order to understand the benefits of the present invention. For example, in FIG. 1, a roadway 10 is shown that included multiple lanes 12, and a subset of the multiple lanes was one or more charging lanes 14. The road segments may include road attributes including a lane charging attribute that indicates whether a particular lane is a charging lane. The road attribute indicated that a lane is equipped with charging or capable of being a charging lane.

The roadway 10 included one or more indicators 16 that indicated that a charging lane was a charging lane. One or more of the indicators 16 was a permanent indicator, such as paint or reflectors on the roadway surface 18. A charging controller 20 or the charging devices 22 embedded in or on the roadway 10 may control and/or power the temporary indicators 16.

Alternatively, the temporary indicator 16 could also be controlled by the charging controller 20. The charging devices 22 could be placed along the roadway 10 at specific intervals. Faster roadways may include charging devices 22 at a smaller interval. For example, charging devices 22 on arterial roads may have a first interval (e.g., small intervals), charging devices 22 on collector roads may have a second interval (e.g., medium intervals), and/or charging devices 22 on local roads may have a third interval (e.g., large intervals). The interval for charging devices 22 may be inversely proportional to the speed of the road because charging can be received better as vehicles are traveling slower and spend more time adjacent to the charging devices 22.

The charging devices 22 may be staggered such that certain charging devices 22 are on and certain charging devices 22 are off at any given time. For example, the charging controller 20 could establish multiple modes of coverage for the charging devices 22. A high mode of coverage may include activation of all of the charging devices 22, which maximizes the electrical charge received by the vehicles. A medium mode of coverage may include activation of less than all of the charging devices 22 (e.g., every other charging device, every third charging device, every fourth charging device, or another percentage of the charging devices), which provides a medium level of electrical charge received by the vehicles. A low mode of coverage may include activation of low number of the charging devices 22 (e.g., every third charging device, every fourth charging device, or another percentage of the charging devices), which provides a low level of electrical charge received by the vehicles.

An important aspect of the prior art is also shown in the power source for the charging devices 22 of the charging lane 14. FIG. 1 shows that the power source 24 is an electrical power grid.

Similarly, FIG. 2 shows that the power source is solar and/or wind power.

Unfortunately, all of the power sources in the prior art require a direct connection to an electrical power grid, or a connection to an unreliable power source. For example, solar power only works during daylight hours and may not work on days with cloud cover. Likewise, wind power only works if there is sufficient wind to generate electricity and therefore does not work when the winds are calm.

Furthermore, the solar and wind power options may simply not be available near to the charging lanes 14 of the roadway 10. While backup batteries might be provided, batteries would substantially increase the cost of using solar or wind power.

Accordingly, it would be an advantage over the prior art to provide alternate means of providing power to charging roadways when access to an electrical power grid is not possible or impractical. It would be another advantage if the power was available during the day and night, in calm weather and stormy weather, and regardless of cloud cover. It would be another advantage if the power source did not require a significant amount of space and if it did not require a costly backup power supply such as batteries.

### BRIEF SUMMARY

The present invention is a system and method for providing a variable amount of electrical power according to varying electrical demands, wherein a fuel cell system varies the amount of hydrogen gas that is generated in order to vary the amount of electricity that is generated, the system modifying the size and surface area of aluminum particles that are inserted into the reaction vessel, the system using a pressure control system to regulate the pressure of hydrogen gas within the reaction vessel, the system regulating the transfer rate of hydrogen, and the system regulating the volume of hydrogen gas that is transferred to a hydrogen conversion system to thereby vary the amount of electricity that is generated by the fuel cell system.

In a first aspect of the invention, the system may balance the size and surface area of aluminum particles within a reaction chamber in order to adjust to a variable rate of electricity demand.

In a second aspect of the invention, the system may monitor and adjust the aluminum particles being used in a reaction vessel depending upon the rate of electricity generation required.

In a third aspect of the invention, the system may adjust and modify the pressure within the reaction vessel in order to optimize the generation of electricity.

In a fourth aspect of the invention, the system may adjust the rate of extraction of hydrogen gas to thereby change the rate of electricity generation.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a top view of a roadway that includes a charging lane as taught in the prior art, wherein the power source is an electrical power grid.

FIG. 2 is a top view of a roadway that includes a charging lane as taught in the prior art, wherein the power source is solar or wind power.

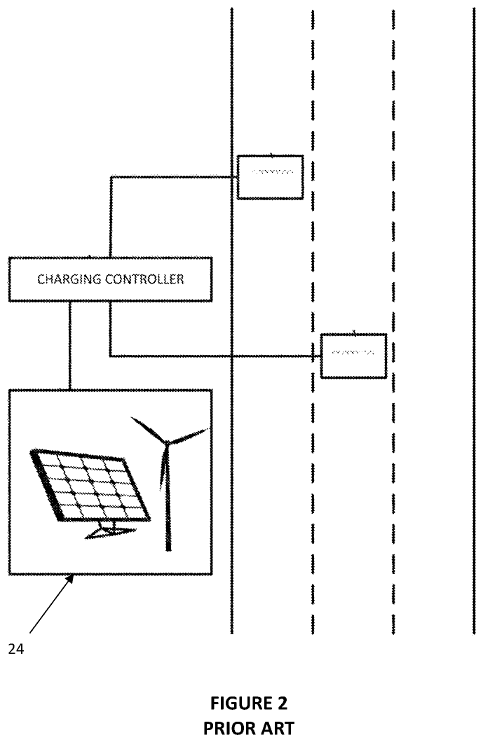

FIG. 3 is a top view of a roadway that includes a charging lane as taught in the prior art, wherein the power source is at least one hydrogen fuel cell.

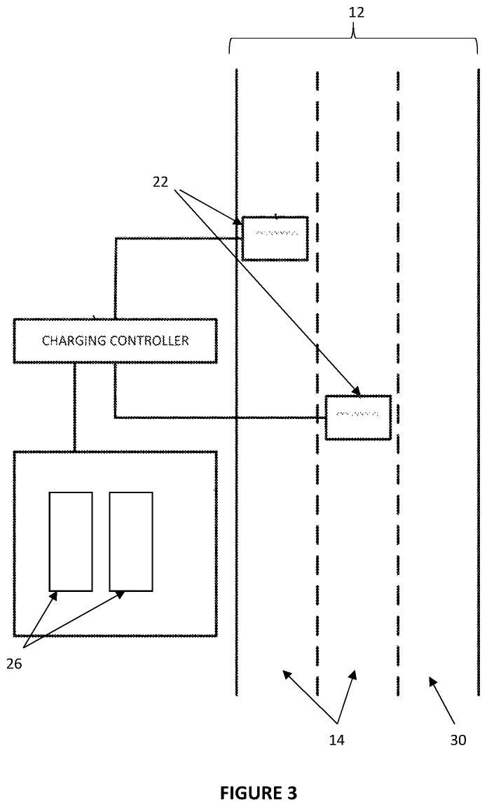

FIG. 4 is top view of an alternate embodiment of the present invention where the charging lanes 14 are now separated from the roadway.

FIG. 5 is the first embodiment of a system that may be modified in accordance with the principles of the present invention.

FIG. 6 is a second embodiment of a system that may be modified in accordance with the principles of the present invention.

FIG. 7 is the first embodiment of a system that may be modified in accordance with the principles of the present invention.

FIG. 8 is a block diagram of the operation of the system that is capable of providing variable rates of electricity depending upon the electrical demands upon the system.

FIG. 9 is a block diagram of the components of a fuel cell system as described in the embodiments of the invention.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

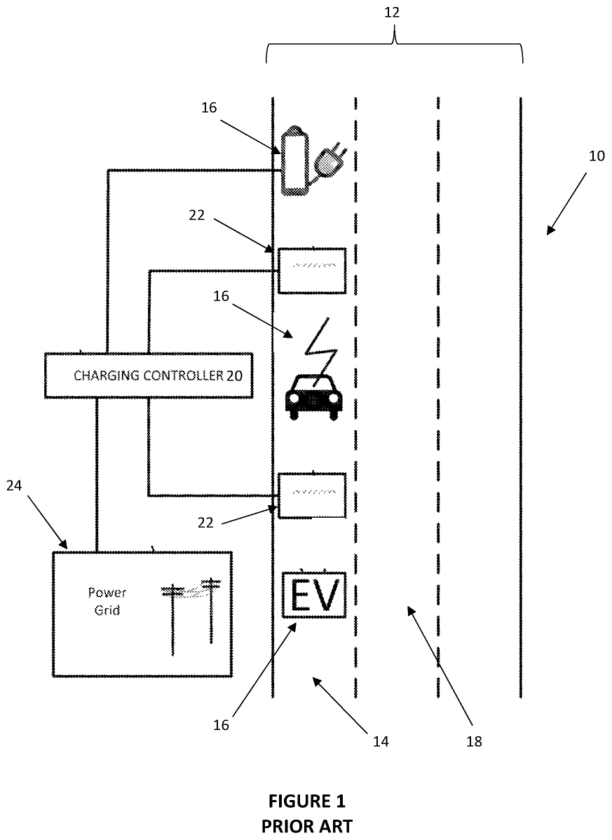

FIG. 1 is a top view of a first embodiment of the invention, wherein a roadway 10 is comprised of lanes 12 that are both charging lanes 14 and non-charging lanes 30. The power source in the first embodiment of the invention may be one or more hydrogen fuel cells 26. The fuel cells 26 may be highly efficient and self-contained hydrogen fueled systems.

Fuel cells operate like batteries, but they do not run down or need recharging. They produce electricity and heat as long as fuel is supplied. A fuel cell consists of two electrodes—a negative electrode (or anode) and a positive electrode (or cathode) that is disposed around an electrolyte. A fuel, such as hydrogen, is fed to the anode, and air is fed to the cathode. In a hydrogen fuel cell, a catalyst at the anode separates hydrogen molecules into protons and electrons, which take different paths to the cathode. The electrons go through an external circuit, creating a flow of electricity that may be used to power the charging lanes 14 as shown in FIG. 1. The protons migrate through the electrolyte to the cathode, where they unite with oxygen and the electrons to produce water and heat.

In the case that hydrogen may be difficult to store at the location of the charging lanes 14, other fuels that are easier to store may also be used to power a fuel cell. For example, natural gas is easier to store and is plentiful.

Natural gas is primarily composed of methane (CH4), so the hydrogen needs to be separated from the carbon to be used in the fuel cell. This separation typically takes place in a device called a steam methane reformer that subjects the natural gas to steam at high temperature and pressure in the presence of a metal catalyst, usually nickel, that facilitates a chemical reaction which produces hydrogen, and small amounts of carbon dioxide and carbon monoxide. The resultant hydrogen is then fed to the fuel cell and the other gases are vented. Water output from the fuel cell can be captured and routed to the reformer, thereby recycling it to be heated into steam for the methane reformation process.

Fuel cells are energy-efficient since they produce electricity chemically rather than through combustion. Depending on the type of fuel cell, efficiency ranges from a low of 40 percent to a high of 80 percent and the electrical output ranges from 200 watts to 2.4 megawatts providing scalable options to meet the needs of even the most demanding charging roadway.

In addition, any fuel source that will work with a fuel cell should be considered to be within the scope of the invention. These fuel sources include all hydrogen-rich fuels such as methanol, ethanol, and hydrocarbon fuels that may be reformed to produce hydrogen.

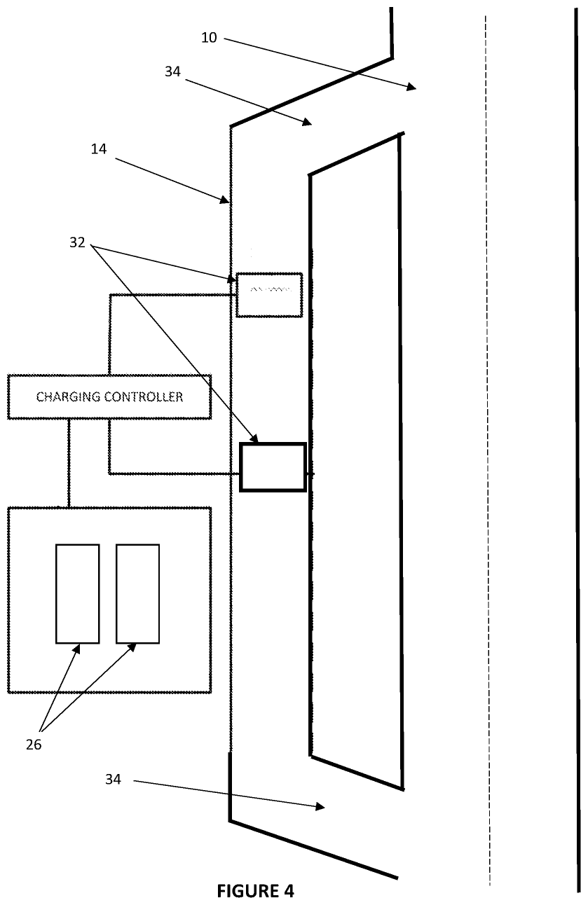

FIG. 4 is a top view of an alternate embodiment of the present invention. In this embodiment, the charging lane 14 is now separated from the non-charging roadway 10 and may be a separate roadway that is accessed by an on and off ramp 34. The charging lane 14 may be adjacent and parallel to the roadway 10 and enable charging vehicles to be out of regular non-charging traffic.

One advantage of this embodiment is that the vehicles using it for charging may travel at a speed that is optimized for charging, which may not be the speed of the roadway 10. Furthermore, the charging lane 14 may also include charging spots 32 where the vehicles pull off the main roadway 10 and come to a stop over a charging spot 32. Thus, this embodiment includes a charging lane 14 and charging spots 32 giving the driver the option of stopping or traveling but at a slower rate than the regular roadway 10.

An important aspect of the invention above is the ability to make adjustments to the rate at which hydrogen is generated by a hydrogen fuel cell. For example, the power demands of the roadway 10 may vary because of the usage of the roadway. In other words, sometimes there may be more vehicles needing charging and at other times there may be fewer vehicles requiring charging.

Thus, another aspect of the invention is to make changes to the rate at which hydrogen gas is generated by a fuel cell.

An example of a hydrogen cell fuel system that may be modified to generate varying amounts of hydrogen is the system taught in U.S. Pat. No. 8,858,910. This patent teaches three embodiments for a hydrogen fuel cell that is able to make automated adjustments to hydrogen fuel production through the use of a pressure regulator. The present invention seeks to improve upon the design.

Hydrogen is a “clean fuel” because it can be reacted with oxygen in hydrogen-consuming devices, such as a fuel cell or combustion engine, to produce energy and water. Virtually no other reaction byproducts are produced in the exhaust. As a result, the use of hydrogen as a fuel effectively solves many environmental problems associated with the use of petroleum-based fuels. Safe and efficient storage of hydrogen gas is, therefore, essential for many applications that can use hydrogen. In particular, minimizing volume, weight and complexity of the hydrogen storage systems are important factors in mobile applications.

The development of fuel cells as replacements for batteries in portable electronic devices, including many popular consumer electronics such as personal data assistants, cellular phones and laptop computers is dependent on finding a convenient and safe hydrogen source. The technology to create small-scale systems for hydrogen supply, storage and delivery has not yet matched the advancements in miniaturization achieved with fuel cells.

A hydrogen fuel cell for portable applications needs to be compact and lightweight, have a high gravimetric hydrogen storage density, and be operable in any orientation. Additionally, it should be easy to match the control of the system's hydrogen flow rate and pressure to the operating demands of the fuel cell.

It should be noted that while the '910 patent is directed to portable applications, the same principles are also suitable for stationary deployments such as the situation of providing power to a remote roadway.

The existing hydrogen storage options, which include compressed and liquid hydrogen, hydride metal alloys, and carbon nanotubes, have characteristics which complicate their use in small consumer applications. For instance, compressed hydrogen and liquid hydrogen require heavy tanks and regulators for storage and delivery, metal hydrides require added heat to release their stored hydrogen, and carbon nanotubes must be kept pressurized.

Alternatives for hydrogen storage and generation include the class of compounds known as chemical hydrides, such as the alkali metal hydrides, the alkali metal aluminum hydrides and the alkali metal borohydride. The hydrolysis reactions of many complex metal hydrides, including sodium borohydride, (NaBH4) have been commonly used for the generation of hydrogen gas.

In those applications where a steady and constant control of hydrogen is required, it is possible to construct hydrogen generation apparatus that control the contact of a catalyst with the hydride fuel. Such generators typically use a two-tank system, one for fuel and the other for discharged product. The hydrogen generation reaction occurs in a third chamber that contains a metal catalyst and connects the two tanks. However, such two-tank designs are not typically directionally independent or amenable to miniaturization.

Again, while the prior art was directed to a small or miniaturized application, the principles of the present invention are amenable to using the teaching of the '910 patent and modifying it for stationary and non-mobile applications.

Accordingly, it is an object of the present invention to provide a device for and method of storage and generation of hydrogen for autonomous current sources based on fuel cells, which constitutes a further improvement of the existing solutions.

In keeping with these objects and with others which will become apparent hereinafter, one feature of the present invention resides, briefly stated, in a device for producing hydrogen for power sources, comprising a housing; means for containing electrolyte in said housing; means for containing aluminum in said housing; means for periodically bringing the aluminum and the electrolyte in contact for production of hydrogen; and means for the withdrawing the hydrogen to a power source.

In accordance with the present invention, another feature of the present invention resides, briefly stated, in a method further comprising setting a predetermined pressure in said container so that when an interior of said housing is connected with a power source, a pressure which is lower than the said pressure is provided inside said container and the aluminum is brought in contact with the electrolyte, while after generation of hydrogen and withdrawal from said container when a pressure becomes again equal to the said pressure the aluminum and electrolyte are disengaged from one another and generation of hydrogen is stopped until a next cycle.

In the present invention the hydrogen production is performed by aluminum assisted water split in accordance with the following formula:

2Al+6H2O[in alkaline solution]→2Al(OH)3+3H2↑

As a result of the reaction of aluminum with water in alkaline medium, a pure hydrated aluminum oxide is produced (AlOH3·nH2O) and hydrogen. The yield of hydrogen can be substantially 3.7%. Taking into consideration that a quantity of water required for reaction can be provided in half by a returned water generated in the electrochemical power system based on the fuel cell during the use of an energy device, the yield of hydrogen can reach 7-10%. The necessary condition of the reaction is a direct contact of all reactants (aqueous alkaline solution and aluminum) with each other. The quantity of produced hydrogen can be regulated by the magnitude of area of contact of the surfaces of particles of aluminum which interact with water.

The prior art taught that the aluminum can be used in any form, such as foil, sheet, wire, granules (pellets) of regular and irregular shape. It is important to provide an optimal area of surface of reaction and its completeness. It is important that one of the linear sizes of the used form of aluminum parts is small and does not exceed 0.1-1 mm.

The important feature of the present invention is also the content of the electrolyte, in particular NaOH with addition of LiOH, NaInO2 and Na4Ga2O3*nH2O.

The required quantities include 4 M of NaOH with 1-10 Wt % of the above-mentioned additives.

The invention itself, however, both as to its construction and its method of operation, together with additional objects and advantages thereof, will be best understood from the following description of specific embodiments when read in connection with the accompanying drawings.

The prior art may require modification in at least three ways in order to comply with the new requirements of variable power generation in a stationary facility.

The first method of modification may be directed to the aluminum particles that interact with the electrolyte to generate hydrogen. In the prior art, a single dimension of aluminum particles was selected. However, this limitation is unsatisfactory for the present invention. The first modification is to provide a variety of different sizes and surface areas of aluminum particles that interact with the present invention.

Furthermore, the second method of modification of the prior art is to introduce the variety of different sizes and surface areas of aluminum particles in order to generate hydrogen gas and thus electricity at a specific and desired rate.

The third method of modification of the prior art may be directed to the release of pressure from an interaction chamber. When the aluminum particles are introduced to the electrolyte, the interaction generates hydrogen gas and consequently, an increase in pressure within the interaction chamber. The prior art teaches a pressure release system that is only capable of releasing pressure at a single pressure level. In contrast, the present invention introduces a system to release pressure at various levels of pressure that may vary depending upon the needs of power generation of the system. Accordingly, a more sophisticated control system may be needed in order to 1) balance the size and surface area of aluminum particles within a reaction chamber, 2) monitor and adjust the aluminum particles depending upon the rate of electricity generation required, 3) adjust and modify the pressure within the reaction chamber in order to optimize the generation of electricity, and 4) adjust the rate of extraction of hydrogen gas to thereby change the rate of electricity generation.

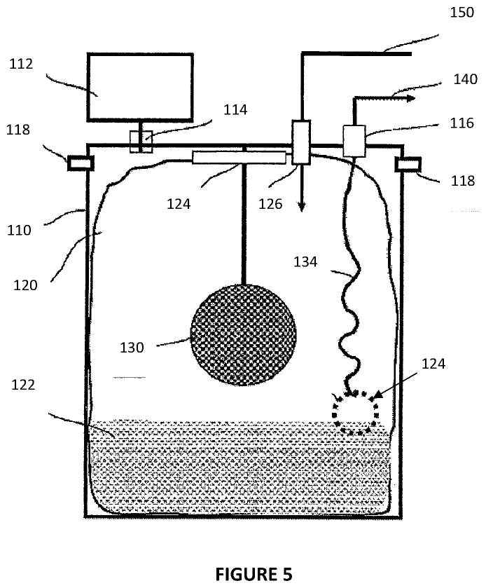

A device for hydrogen gas generation in accordance with one embodiment of the present invention is shown in FIG. 5. The device has a housing 110, a unit for setting a controlling pressure 112, a sealing unit 114 for sealing introduction of gas which sets the pressure, a unit 116 for sealing a pipe for supply of a generated hydrogen to a fuel cell, and a unit 118 for sealing a removable lid of the device. The device further has a flexible bay 120 formed as an electrolyte container for accommodating electrolyte 122. The device further has a container 130 with a portion of aluminum, and a unit 124 for sealing the container with aluminum.

Reference numeral 126 identifies a unit for sealing a pipe for return of water from the fuel cell. The device further has unit 132 for filtration and withdrawal of generated hydrogen from the device, a flexible pipe 134 for withdrawal of the generated hydrogen from the flexible back 132, a pipe 140 for supplying the generated hydrogen to a fuel cell, and a pipe 150 for return of water from the fuel cell into the device.

The housing 110 may be composed of rigid material, for example from a thermoplastic material such as polyamide, ABC, and thermoreactive plastic material such as fluoroplastics or silicon elastomers. The container 120 for electrolyte is composed of an elastic material, for example from rubber EPDM or silicon rubber, and accommodates a required quantity of electrolyte needed for the chemical reaction. The container 130 with a portion of aluminum, the sealing unit 124, and the unit for filtration and removal of generated hydrogen is located inside the container 120.

The unit 132 for filtration and removal of the generated of the united hydrogen is connected through the sealing unit 116 by the flexible pipe 134 with a pipe for supply of hydrogen 140 to the fuel cell. The device for setting controlling pressure 112 is connected through the sealing unit 114 to the housing 110, and the pipe for return of water from the fuel cell 150 is connected to the housing 10 through the sealing unit 126. The housing 110 is composed of two parts connected with one another by the sealing unit 118.

In the initial position the device formed as a cartridge may not have active components. In order to supply the components into the cartridge, it is necessary to open the housing 110 in the sealing unit 118 which can be formed as screw connection, a bayonet connection or another fast connection, to disconnect the sealing unit 124, to pour aqueous solution, for example of 4 M Na OH with additives 1-10 Wt % LiOH, NaInO2 and Na4Ga2O3*nH2O into the electrolyte container 120, to place the container 130 with a portion of aluminum inside the container 120, to seal the sealing unit 124, to seal the housing 110.

For activation of the device, it is necessary to connect the pipe for supply of hydrogen 140 to the fuel cell, and the pipe for return of water 150 to a corresponding part of the fuel cell.

After the connection of the pipe 140, insufficient pressure, relative to pressure set by the unit 112, is provided. This leads to squeezing of the electrolyte container 120 which is composed of elastic material, and the electrolyte 122 is brought into contact with the aluminum in the container 130, so that in accordance with the above-mentioned reaction, generation of hydrogen starts. This process continues until the pressure inside the container 120 becomes equal to the pressure set by the setting unit 112. In the prior art, after the pressures inside the elements 112 and 120 become equal, electrolyte and aluminum are disconnected, and reaction of generation of hydrogen automatically stops until a next cycle. The next cycle starts when the pressure of hydrogen in the fuel cell again becomes smaller than the pressure set by the unit 112, and the process continues until a complete use of the reactants. As can be seen, the device formed as a cartridge can operate in any spatial orientation.

However, in this embodiment, the container 130 with a portion of aluminum may now be replaced with a different container 130 containing aluminum particles that are now optimized for a different rate of reaction with the electrolyte, and consequently, a different rate of electricity generation.

After the complete use of the reactants, the device is disconnected from the fuel cell and is recharged. For this purpose the housing 110 is open in the sealing unit 118, the sealing unit 124 is disconnected, the container 130 is removed from the container 120, the spent solution of electrolyte is removed from the container 120, and the container is washed, while the spent solution may be sent for recycling, a fresh solution specified herein above is introduced into the electrolyte container 120, the container 130 with a portion of aluminum is introduced into the container 120, the sealing unit 120 is sealed, the housing 120 is sealed, and the device is ready for next use.

In this embodiment, this replacement of the electrolyte 122 is also automated. Furthermore, the aluminum particles in the container 120 may be left in the electrolyte 122 for longer periods of time to thereby obtain a higher pressure.

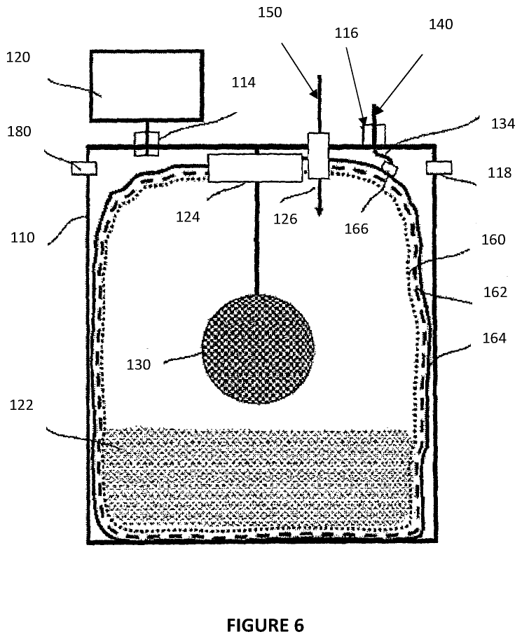

In a second embodiment of the invention shown in FIG. 6, this embodiment describes a device that is similar to the first embodiment, but the bladder now contains a gas permeable membrane that is used to pass the hydrogen from the reaction outside the bladder so that it can be directed to a reaction chamber.

FIG. 6 shows the second embodiment of the device in accordance with the present invention. The device has a housing 110, a unit 112 for setting controlling pressure, a unit 114 for sealing introduction of gas that sets by pressure, a unit 116 for sealing a pipe for supply of generated hydrogen into a fuel cell, and a unit 118 for sealing a removable lid of the device. Reference numeral 122 identifies electrolyte. The device further has a container 130 with a portion of aluminum, a unit 124 for sealing the aluminum container, a unit 126 for sealing a pipe for return of water from a fuel cell, and a flexible pipe 134 for removal of generated hydrogen from the flexible bag.

The device further has a pipe 140 for supplying generated hydrogen to the fuel cell, and a pipe 150 for return of water from the fuel cell into the device. The device further has an internal bag 160 composed of a porous hydrophobic membrane which allows a passage of hydrogen through a net 162 which can be formed as a plastic net and reinforced for providing a required gap between the internal bag 160 and a flexible bag 164. The flexible bag 164 is impermeable for hydrogen and electrolyte. Reference number 166 identifies a unit for withdrawal of hydrogen from the device.

In the device shown in FIG. 6 the housing 110 is also composed of rigid material as in the embodiment of FIG. 5. The container formed as a bag for electrolyte 164 is located inside the housing and composed of an elastic material such as EPDM rubber or silicon rubber with a supply of the electrolyte 122, and the container with a portion of aluminum 130. The internal bag 160 is composed of a gas permeable membrane known in the art and more permeable to hydrogen than water, such as silicon rubber, fluoropolymer, or any common hydrogen-permeable metal membrane, such as palladium-gold alloy membrane. Another bag 162 composed of a plastic mesh or net, for example of polyethylene or polypropylene fluoroplastic and another material which is resistant in alkali solutions, is provided between the elements 160 and 164 for obtaining a gap therebetween. The container 130 with a portion of aluminum and electrolyte 122 are introduced into the container 164 through the hermetically sealed window 124. The unit for withdrawal of hydrogen 166 is arranged on the container 164 and connected by the flexible pipe 134, which through the sealing unit 16 is connected with the pipe 140 for supply of hydrogen to the fuel cell. The unit 112 for setting controlling pressure and the pipe for return of water from the cell 150 are connected through the sealing unit 114 and the sealing unit 126 correspondingly to the housing 110. The housing 110 is composed of two parts connected with one another by the sealing unit 118.

As in the previous embodiment, in the initial position there are no reactants in the device. It is then necessary to open the housing 110 in the area of the sealing unit 118, to disconnect the sealing unit 124, to introduce the electrolyte into the container 120, to place the container 130 with a portion of aluminum into the container 160-164, and to seal the unit 124 and the housing 110.

In order to activate the device, it is necessary to connect the device 140 for supply of hydrogen to the fuel cell and the pipe of 150 for return of water to the corresponding parts of the fuel cell. After the connection of the pipe 140 an insufficient pressure relative to the pressure set by the unit 112 is provided. This leads to squeezing of the composite container for electrolyte 160-164, which is composed of the elastic material, the electrolyte 122 is brought in contact with aluminum in the container 130, and hydrogen is generated in accordance with the above-mentioned reaction. After equalization of the pressure inside the elements 120 and 164, the electrolyte and aluminum are disengaged from one another and the reaction of generation of hydrogen automatically stops until the next cycle. The next cycle starts when pressure of hydrogen in the fuel cell again becomes lower than the pressure set by the unit 112, and the process continues until full use of reactants.

After the complete use of reactants, the device is disconnected from the fuel cell and is recharged. For this purpose the housing 110 is open in the area of the sealing unit 118, the sealing unit 124 is disconnected, the container 130 is removed from the composite container 160-164, the electrolyte is removed from the container 120 and washed, and the spent solution is sent for recycling, a fresh solution of the electrolyte is introduced into the composite container 160-164, the container 130 with the portion of aluminum is introduced into the composite container 160-164, the unit 124 is sealed, and the housing 110 is sealed.

Again, the second embodiment is modified just as the first embodiment in order to adapt the system for use in a system that may generate hydrogen gas and thus electricity at different rates. The system is modified by providing a means for introducing aluminum particles having different sizes and surface areas in order to modify the reaction rate between the aluminum particles and the electrolyte.

Furthermore, the pressure within the composite chamber 160-164 is now controlled using a different pressure release system that enables higher pressures to be created within the chamber. This pressure modification requires a more sophisticated pressure control system.

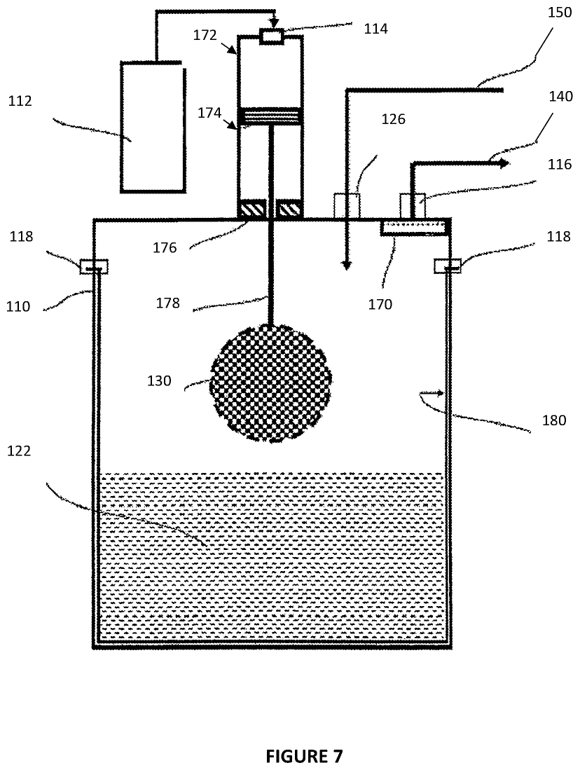

In a third embodiment shown in FIG. 7, another embodiment of the present invention shows that the device for hydrogen generation has a housing 110, a unit 112 for setting controlling pressure, a unit 114 for sealing introduction of gas which sets the pressure, a unit 116 for sealing a pipe for supply of generated hydrogen to a fuel cell, and a unit 118 for sealing a removable lid of the device. Reference numeral 122 identifies electrolyte. The device further has a unit 176 for sealing the container with aluminum, a unit 126 for sealing a pipe for return of water from the fuel cell, a container 130 with a portion of aluminum, a pipe 140 for supply of generated hydrogen to the fuel cell, a pipe 150 for return of water from the fuel cell, a unit 170 for removal of hydrogen from the device, a cylinder 172 providing a displacement of aluminum container by means of a piston rod 178 under the action of the gas from the unit 112, a piston 174, and a unit for sealing the piston rod 178. The device further has a flexible bag 180 which is impermeable for hydrogen and electrolyte.

In order to enable control over the pressure, the piston 174 may now be controlled to enable the pressure to increase within the housing unit 110. The unit 112 for setting controlling pressure is now modified so that the pressure on the piston 174 may be adjustable and not set at a fixed amount.

As before, the housing 110 is composed of a solid material, for example a plastic material. The container or bag for electrolyte 180 composed of an elastic material, for example, of EPDM rubber or silicon rubber or plastic with the electrolyte 122 is located in the housing. The housing 110 is composed of two parts removably connectable by the sealing unit 118. The electrolyte container 180 is connected to the housing 110 in the area of the sealing unit 118. The unit for filtration and removal of hydrogen 170 with the pipe 140 for supply of hydrogen to the fuel cell and the device for regulating the position of the container 130 with aluminum relative to the level of the electrolyte 120 are located in an upper part of the housing 110. This regulating device includes the unit 112 for setting a controlled pressure, the cylinder 172 with the piston 174, the piston rod 178 and the sealing unit 176, the pipe 150 for water return from the fuel cell through this sealing unit 126. The pipe 150 for return of water from the fuel cell is connected to the housing 10 through the sealing unit 126.

As in the previous embodiments for introducing reactants it is necessary to open the housing 110, to introduce the electrolyte into the container 180, to connect the container 130 with aluminum to the piston rod 178 at a corresponding height, to seal the housing 110.

For activation of the device it is necessary to connect the pipe 140 for hydrogen to the fuel cell and the pipe 150 for water return to the corresponding part of the fuel cell. Immediately after the connection of the pipe 140 an insufficient pressure relative to the pressure set by the unit 120 is produced. This leads to lowering of the container 130 with aluminum until its contact with the electrolyte 122, and they are brought in contact with one another, whereafter in accordance with the above-mentioned reaction generation of hydrogen begins. The process will continue till the pressure inside the housing 110 equalizes with the pressure set by the unit 112. After the equalization of the pressures the container 130 with aluminum connected to the piston rod 178 moves upwardly, the electrolyte and aluminum are disengaged with one another, and the reaction stops until the next cycle. The next cycle starts when the pressure of hydrogen in the fuel cell transmitted into the housing 110 is again less than the pressure set by the element 112, and the process continues until complete use of the reagents. The device can work in a substantial vertical position +/−30°. After the use of the reactants the device is disconnected from the fuel cell and is recharged/replaced correspondingly.

It should be mentioned that the container 130 for aluminum is configured so as to provide a contact with the electrolyte with the aluminum in the container. The container 130 may be formed as a mesh, net, etc., which allows the above-mentioned contact. An important feature of the present invention is that the aluminum is provided in the form of small particles with a thickness substantially not exceeding 0.1-1 mm. This provides a high degree of contact between the aluminum and the electrolyte and high efficiency of the process.

The inventive device and method have been tested. An example is presented below just for illustration purposes and is not to be constructed as limitation of the present invention, since many deviations are possible without a parting of the spirit and scope of the invention.

It will be understood that each of the elements described above, or two or more together, may also find a useful application in other types of constructions and methods differing from the type described above.

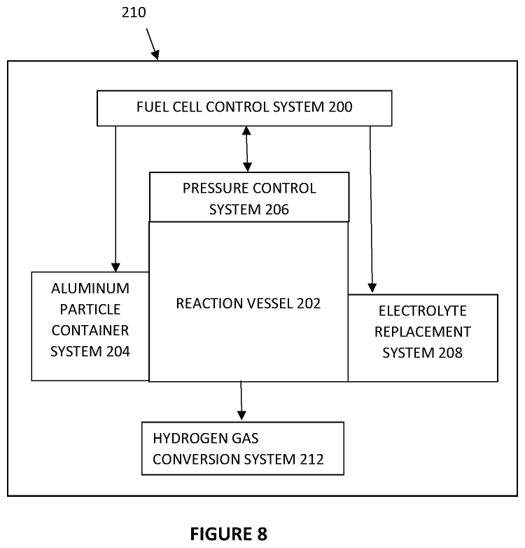

FIG. 8 is a block diagram that illustrates the modifications made to the prior art in order to be able to meet the flexible power generation requirements of a fuel cell system 210 in the embodiments of the invention. A control system 200 may be a processer such as a microprocessor that controls operation of the fuel cell system 210 including a reaction vessel 202 wherein the aluminum particles react with an electrolyte, an aluminum particle container system 204, a pressure control system 206, an electrolyte replacement system 208, and a hydrogen gas conversion system 212.

According to a first embodiment of the fuel cell system 210, the control system 200 sends instructions to the aluminum particle container system 204 that includes a variety of aluminum particle containers that contain different sizes and/or surface areas of aluminum particles. Depending on the rate of electricity generation that is needed, the control system 200 sends instructions to the aluminum particle container system 204 to insert a specific aluminum particle container into the reaction vessel 202.

The control system 200 also sends and receives information from the pressure control system 206 that controls the pressure within the reaction vessel 200. The pressure control system 206 sends information to the control system 200 so that it is always aware of the pressure within the reaction vessel 202. Adjustments may need to be made to the pressure within the reaction vessel 202 to thereby change the rate of reaction within the reaction vessel.

The condition of the electrolyte within the reaction vessel 202 may need modification as the reactions take place within the reaction vessel. The control system 200 may therefore replace the electrolyte within the reaction vessel 202 as needed in order to keep the rate of reaction at the desired level. The electrolyte replacement system 208 may be used to drain used electrolyte from the reaction vessel 202 and replace it with fresh electrolyte.

The pressure control system 206 enables the release of hydrogen gas from the reaction vessel 202 to the hydrogen gas conversion system 212 where hydrogen gas is then converted into electricity. The volume of hydrogen gas that is transferred and the rate at which it is transferred may be factors that determine how much electricity is generated by the hydrogen gas conversion system 212.

It is understood that systems that may be used for introducing different aluminum particle containers to the reaction vessel 202, and for draining and replacing electrolyte in the reaction vessel 202 are known to those skilled in the art. What is important to the embodiments of the invention is that these capabilities be provided in this first embodiment of the fuel cell system 210 in order to be able to provide variable electricity output from fuel cells of the present invention.

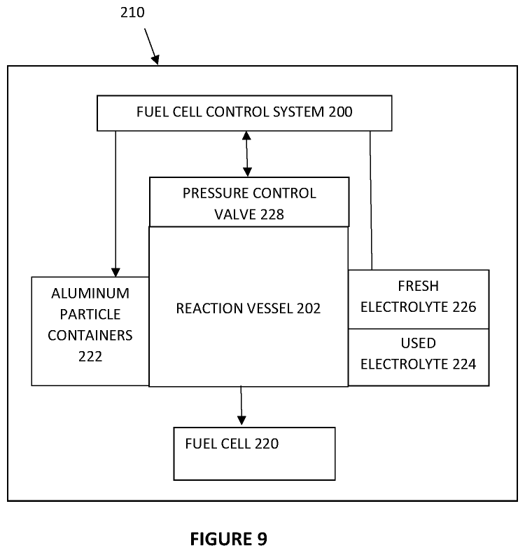

In summary and as shown in FIG. 9, the embodiments of the include a fuel cell system 210 for generating hydrogen gas from a fuel cell 220, and wherein the fuel cell is capable of variable hydrogen gas output, said fuel cell system comprised of the reaction vessel 202 for enabling a reaction between aluminum particles and an electrolyte to thereby generate hydrogen that is used to generate electricity from the fuel cell, a plurality of aluminum particle containers 222 for selecting a container and inserting the container into the reaction vessel, and then removing the container when done, an electrolyte replacement system for draining used electrolyte from the reaction vessel and into a use electrolyte container 224 and filling the reaction vessel with replacement electrolyte from a fresh electrolyte container 226, a pressure control system including a pressure control valve 228 for controlling the amount of pressure in the reaction vessel, and a fuel cell control system 200 for coordinating operation of the aluminum particle container system, the electrolyte replacement system, and the pressure control system.

The fuel cell system 210 having the plurality of aluminum particle containers 222, includes an insertion and extraction system for selecting one of the plurality of aluminum particle containers, inserting the selected container into the reaction vessel, and then removing the selected container from the reaction vessel.

The aluminum particle container system is further comprised of the plurality of aluminum particle containers 222 each having a specific size of aluminum particle, wherein the size of the aluminum particles is selected to create a specific reaction rate within the reaction vessel.

The electrolyte replacement system includes at least one container 224 for holding used electrolyte, and at least one container 226 for holding fresh electrolyte replacement.

The method for generating hydrogen gas from a fuel cell, wherein the fuel cell is capable of variable hydrogen gas output, is a method comprising the steps of providing a reaction vessel for enabling a reaction between aluminum particles and an electrolyte to thereby generate hydrogen gas, providing an aluminum particle container system for performing insertion and removal of a container of aluminum particles from the reaction vessel, providing an electrolyte replacement system for draining used electrolyte from the reaction vessel and filling the reaction vessel with replacement electrolyte, providing a pressure control system for controlling the amount of pressure in the reaction vessel, and providing a fuel cell control system for coordinating operation of the aluminum particle container system, the electrolyte replacement system, and the pressure control system.

The next step is dispensing fresh electrolyte from the electrolyte replacement system into the reaction vessel, and then inserting a container of aluminum particles from the aluminum particle containment system into the reaction vessel.

The pressure of the hydrogen gas within the reaction vessel is controlled using the pressure control system.

The next step is transferring hydrogen gas from the reaction vessel to the hydrogen gas conversion unit, and then generating electricity in the hydrogen gas conversion unit or fuel cell 220 using the hydrogen gas that is transferred.

The final step is controlling how much electricity is generated by controlling factors such as pressure of the hydrogen gas within the reaction vessel, the size of the aluminum particles disposed in the reaction vessel, the surface area of the aluminum particles disposed in the reaction vessel, the rate that hydrogen gas is being generated within the reaction vessel, and the rate that hydrogen is being transferred from the reaction vessel.

It should be understood that the variable power output of the fuel cell of the present invention may be used in any application where electricity is needed, and not only to the specific example of the roadway given.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A fuel cell system for generating hydrogen gas from a fuel cell, and wherein the fuel cell is capable of variable hydrogen gas output, said fuel cell system comprised of:
a reaction vessel for enabling a reaction between aluminum particles and an electrolyte to thereby generate hydrogen that is used to generate electricity from a fuel cell;
an aluminum particle container system for selecting a container and inserting the container into the reaction vessel, and then removing the container when done;
an electrolyte replacement system for draining used electrolyte from the reaction vessel and filling the reaction vessel with replacement electrolyte;
a pressure control system for controlling the amount of pressure in the reaction vessel; and
a fuel cell control system for coordinating operation of the aluminum particle container system, the electrolyte replacement system, and the pressure control system.

2. The fuel cell system as defined in claim 1 wherein the aluminum particle container system is further comprised of:
a plurality of aluminum particle containers; and
an insertion and extraction system for selecting one of the plurality of aluminum particle containers, inserting the selected container into the reaction vessel and then removing the selected container from the reaction vessel.

3. The fuel cell system as defined in claim 2 wherein the aluminum particle container system is further comprised of the plurality of aluminum particle containers each having a specific size of aluminum particle, wherein the size of the aluminum particles is selected to create a specific reaction rate within the reaction vessel.

4. The fuel cell system as defined in claim 1 wherein the electrolyte replacement system is further comprised of:
at least one container for holding used electrolyte; and
at least one container for holding fresh electrolyte replacement.

5. The fuel cell system as defined in claim 1 wherein the pressure control system is further comprised of an adjustable valve for releasing a gas from the reaction vessel to thereby control a reaction rate within the reaction vessel.

6. The fuel cell system as defined in claim 1 wherein the fuel cell control system is further comprised of:
a processor for executing instructions for operation of the fuel cell system; and
a communication system for communicating with the aluminum particle control system, the pressure control system, and the electrolyte replacement system.

7. The fuel cell system as defined in claim 1 wherein the fuel cell system is further comprised of a hydrogen gas conversion system for converting hydrogen gas into electricity.

8. A method for generating hydrogen gas from a fuel cell, and wherein the fuel cell is capable of variable hydrogen gas output, said method comprising:
providing a reaction vessel for enabling a reaction between aluminum particles and an electrolyte to thereby generate hydrogen gas, providing an aluminum particle container system for performing insertion and removal of a container of aluminum particles from the reaction vessel, providing an electrolyte replacement system for draining used electrolyte from the reaction vessel and filling the reaction vessel with replacement electrolyte, providing a pressure control system for controlling the amount of pressure in the reaction vessel, and providing a fuel cell control system for coordinating operation of the aluminum particle container system, the electrolyte replacement system, and the pressure control system;
dispensing fresh electrolyte from the electrolyte replacement system into the reaction vessel;
inserting a container of aluminum particles from the aluminum particle containment system into the reaction vessel; and
controlling the pressure of hydrogen gas being generated within the reaction vessel using the pressure control system.

9. The method as defined in claim 8 wherein the method further comprises:
transferring hydrogen gas from the reaction vessel to the hydrogen gas conversion unit; and
generating electricity in the hydrogen gas conversion unit using the hydrogen gas that is transferred.

10. The method as defined in claim 9 wherein the method further comprises adjusting how much electricity is generated by controlling factors selected from the group of controllable factors comprised of pressure of the hydrogen gas within the reaction vessel, the size of the aluminum particles disposed in the reaction vessel, the surface area of the aluminum particles disposed in the reaction vessel, the rate that hydrogen gas is being generated within the reaction vessel, and the rate that hydrogen is being transferred from the reaction vessel.

11. The method as defined in claim 9 wherein the method further comprises:
creating a variety of aluminum particles that vary by size and surface area;
creating a plurality of containers for the aluminum particles for storing the aluminum particles according to size and surface area; and
selecting which aluminum particles to insert into the reaction vessel according to the rate at which hydrogen gas is to be generated within the reaction vessel.

12. The method as defined in claim 9 wherein the method further comprises:
draining used electrolyte from the electrolyte replacement system when the reaction rate within the reaction vessel slows down; and
dispensing fresh electrolyte into the reaction vessel.

13. The method as defined in claim 9 wherein the method further comprises modifying the pressure of hydrogen gas within the reaction vessel to thereby modify the rate hydrogen gas creation.
